(19) United States
(12) Patent Application Publication
(10) Pub. No.: US 2008/0006705 A1
(43) Pub. Date: Jan. 10, 2008

(54) Marking Clip for Ic Tray

(75) Inventor: Satoru Furunishi, Saitama-shi (JP)

Correspondence Address: KRATZ, QUINTOS & HANSON, LLP, 1420 K Street, N.W., Suite 400, WASHINGTON, DC, 20005, US

(73) Assignee: DAINICHI CAN CO., LTD.,, Kounosu-shi (JP)

(21) Appl. No.: 10/571,912

(22) PCT Filed: Jul. 5, 2005
(86) PCT No.: PCT/JP05/12408

§ 371 Date: Mar. 14, 2006

(30) Foreign Application Priority Data
Jul. 6, 2004 (JP) 2004-199446

(51) Int. Cl. G06K 19/06

(52) U.S. Cl. 235/494

(57) ABSTRACT

A marking clip (4) for an IC tray is removably attached to an end tab (3) of an IC tray (1), the IC tray (1) being formed in a rectangular thin-plate shape with a plurality of concave housing portions (2) on which are placed semiconductor devices being formed in lengthwise and crosswise aligned rows in a surface of the IC tray (1), and the end tab (3) having an L-shaped cross section and being formed so as to protrude at both edges of short sides of the IC tray (1). This marking clip (4) includes a display piece (5) that is placed on a front surface side of the end tab (3), a press-insertion piece (7) that is press-inserted into a groove (34) in a rear surface side of the end tab (3), and a connecting piece (6) that is placed on an end surface side of the end tab (3) and connects the display piece (5) to the press-insertion piece (7), and, as an identification function to identify an IC tray (1), a display for identification is shown on the display piece (5) or on the connecting piece (6) or a member for identification is attached to the display piece (5) or the connecting piece (6).

### TECHNICAL FIELD

The present invention relates to a marking clip that is used for identifying an IC tray. The present invention further relates to a marked IC tray that is equipped with this marking clip, and to an identification method for identifying IC trays equipped with this marking clip.

Priority is claimed on Japanese Patent Application No. 2004-199446, filed Jul. 6, 2004, the contents of which are incorporated herein by reference.

### BACKGROUND ART OF THE INVENTION

An IC tray is used to contain a plurality of semiconductor devices (including IC chips and the like) that are placed thereon in a regular pattern, and is widely used for the transportation of semiconductor devices to packaging steps and the like. Moreover, recently, during the manufacture of the actual semiconductors themselves, semiconductor devices have been placed on an IC tray in an uncompleted state and the IC tray has been used to transport the semiconductor devices between manufacturing steps. Furthermore, the IC trays are also used when baking processing and the like is performed on semiconductor devices.

The IC trays that are commonly used conform to standards established by the Joint Electron Device Engineering Council (JEDEC), which is an American industrial group for promoting the standardization of electron devices, and have virtually become standard components.

When using this type of IC tray, it is necessary when conducting an operation to recognize what type of condition or situation semiconductor devices contained thereon are currently in. For example, it is not possible to determine simply from the IC tray itself or from the semiconductor devices contained thereon themselves whether the semiconductor devices are in a state prior to baking processing or whether they are in a state subsequent to baking processing.

Because of this, conventionally, it is performed that operators write suitable marks on IC trays using colored ink and the like.

However, it is necessary to frequently change the marks and the like that are applied to an IC tray. This is because semiconductor devices that are contained on the IC tray frequently undergo consecutive different treatments via a plurality of processing steps.

In cases such as this, time and effort are needed to rewrite the marks so that a considerable burden is placed on an operator.

Existing technologies for applying identification marks to electron devices or to containers housing these electron devices are known as follows.

However, applying markings for identification to IC trays in the form of clips has not hitherto been known.
PATENT DOCUMENT 1: Japanese Patent No. 3497251
PATENT DOCUMENT 2: Japanese Examined Utility Model Application, Second Publication No. H07-26842
PATENT DOCUMENT 3: Japanese Unexamined Patent Application, First Publication No. H10-129937
PATENT DOCUMENT 4: Japanese Unexamined Utility Model Application, First Publication No. H05-92868
PATENT DOCUMENT 5: Japanese Unexamined Patent Application, First Publication No. H08-281702
PATENT DOCUMENT 6: Japanese Unexamined Patent Application, First Publication No. H09-188383

### DETAILED DESCRIPTION OF THE INVENTION

### Problems to be Solved by the Invention

It is an object of the present invention to provide a device for identifying IC trays that enables IC trays to be reliably and easily identified, and that enables a large number of classifications to be made without any burden being placed on an operator.

### MEANS FOR SOLVING THE PROBLEM

The present invention proposes a marking clip for an IC tray that is removably attached to an end tab of an IC tray, the IC tray being formed in a rectangular thin-plate shape with a plurality of concave housing portions on which are placed semiconductor devices being formed in lengthwise and crosswise aligned rows in a surface of the IC tray, and the end tab having an L-shaped cross section and being formed so as to protrude at both edges of short sides of the IC tray, including: a display piece that is placed on a front surface side of the end tab; a press-insertion piece that is press-inserted into a groove on a rear surface side of the end tab; and a connecting piece for connecting the display piece to the press-insertion piece, the connecting piece is placed on an end surface side of the end tab, wherein a display for identifying an IC tray is shown on the display piece or on the connecting piece or a member for identifying an IC tray is attached to the display piece or the connecting piece.

In the marking clip for an IC tray of the present invention, it is preferable that the press-insertion piece be pressed against an inner surface of the groove in the rear surface side of the end tab by its own elastic force.

In the marking clip for an IC tray of the present invention, it is preferable that a concave portion that enables the press-insertion piece to be elastically deformed easily be formed in the press-insertion piece such that the press-insertion piece is pressed against side surfaces of the groove by its own elastic force.

In the marking clip for an IC tray of the present invention, it is preferable that a convex portion is formed near a distal end of a top surface of the press-insertion piece such that the press-insertion piece be pressed against bottom surface of the groove by its own elastic force.

In the marking clip for an IC tray of the present invention, it is preferable that the display piece, the press-insertion piece, and the connecting piece be formed as a single body from synthetic resin.

In the marking clip for an IC tray of the present invention, it is preferable that the synthetic resin be provided with conductivity or antistatic properties as a result of a conductive filler or surface active agent being mixed in the synthetic resin.

In the marking clip for an IC tray of the present invention, it is preferable that the display used for identification be a color on the surface of the display piece.

In the marking clip for an IC tray of the present invention, it is preferable that the member used for identification be an IC tag that is attached to or embedded in the display piece or the connecting piece.

The present invention proposes a standardized IC tray that is formed in a rectangular thin-plate shape with a plurality of concave housing portions on which are placed semiconductor devices being formed in lengthwise and crosswise aligned rows in a surface of the IC tray, and an end tab having an L-shaped cross section being formed so as to protrude at both edges of short sides of the IC tray, wherein the marking clip for an IC tray according to the present invention is fitted on the end tab.

The present invention proposes a method of identifying an IC tray that is formed in a rectangular thin-plate shape with a plurality of concave housing portions on which are placed semiconductor devices being formed in lengthwise and crosswise aligned rows in a surface of the IC tray, and an end tab having an L-shaped cross section being formed so as to protrude at both edges of short sides of the IC tray, including: fitting the marking clip for an IC tray according to the present invention on the end tab, and identifying the IC tray by the display for identifying an IC tray or by the member for identifying an IC tray.

### ADVANTAGEOUS EFFECTS OF THE INVENTION

In the present invention, because a display for identification such as various colors, patterns, characters, barcodes, two-dimensional codes and the like are shown on a display piece or connecting piece, or a member for identification such as a tiny radio IC tag (i.e., an RFID tag) that responds via microwaves or the like is attached to or embedded in the display piece or connecting piece, it is possible for IC trays to be classified into a large number of types and identified as such.

Accordingly, it is possible to reliably identify the type of condition or situation semiconductor devices that are contained in an IC tray that is equipped with this marking clip are in.

In the present invention, when the press-insertion piece of a marking clip is inserted into the groove in the rear surface of the end tab of an IC tray, because the marking clip is made from synthetic resin, the press-insertion piece is elastically deformed and becomes housed within the groove.

In addition, the press-insertion piece is pressed by its own elastic repulsion against the internal surfaces of the groove. Namely, the press-insertion piece is elastically in contact with the internal surface of the groove. Because of this, the marking clip cannot fall accidentally from the end tab of the IC tray. Moreover, when removing the marking clip, the marking clip is pulled out, at this time, because the press-insertion piece is slid along the internal surfaces of the groove while being elastically deformed, the marking clip can be removed with only a slight amount of force.

Moreover, in the fitting of the marking clip, when the press-insertion piece is placed in contact with the side surfaces of the groove in the end tab, there is a form in which the press-insertion piece is elastically deformed and held in place in the end tab, and a form in which the end tab is elastically sandwiched between the press-insertion piece and the display piece and is thereby held in place.

Furthermore, in the identification method in which this marking clip is fitted into an end tab of an IC tray, because the press-insertion piece simply needs to be pushed into the groove, or to be pulled out from the groove, the operation is extremely simple, and no burden is placed on the operator. As a result, the operating efficiency is high.

### BRIEF DESCRIPTION OF THE DRAWINGS

FIG. 1 schematic plan view showing an example of an IC tray of the present invention.

FIG. 2 A cross-sectional perspective view showing an end tab of the IC tray of the present invention.

FIG. 3 A perspective view showing an example of a marking clip of the present invention.

FIG. 4 A perspective view showing another example of a marking clip of the present invention.

### DESCRIPTION OF THE REFERENCE SYMBOLS

1 . . . IC tray, 3 . . . end tab, 34 . . . square groove, 4 . . . marking clip, 5 . . . display piece, 6 . . . connecting piece, 7 . . . press-insertion piece, 71 . . . concave portion, 72 . . . convex portion

### BEST MODE FOR CARRYING OUT THE INVENTION

The present invention is described in detail below with reference made to the drawings.

Firstly, an IC tray of the present invention will be described.

The IC tray of the present invention is regulated by standards established by JEDEC, namely, Item CS-003 of the JEDEC Standards.

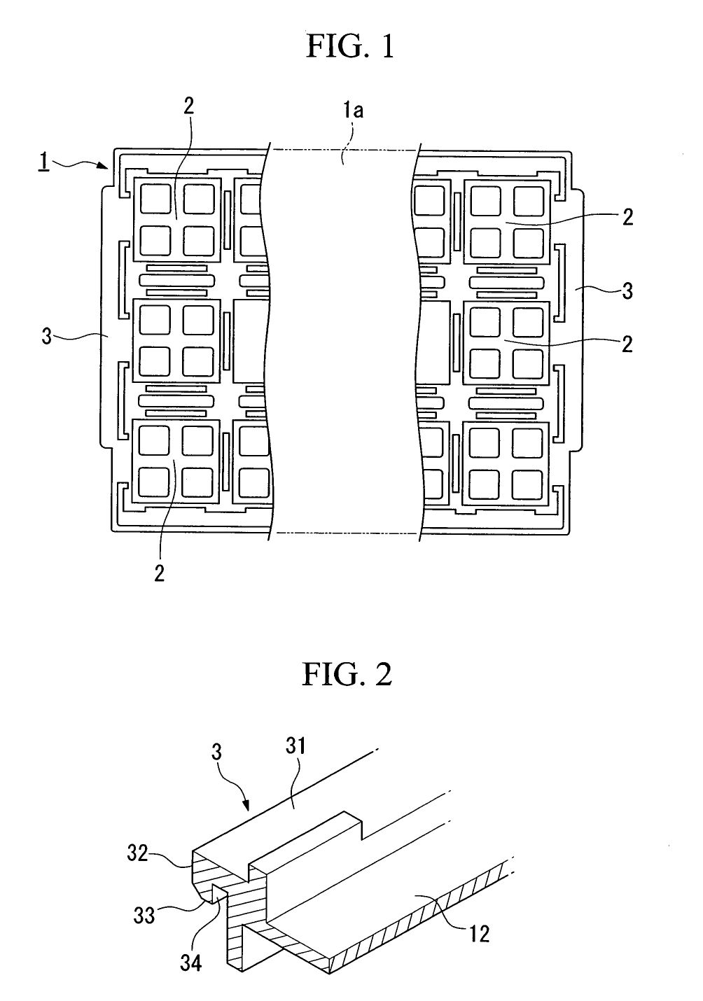

FIG. 1 is a plan view showing an example of an IC tray conforming to this JEDEC Standard. Overall, this IC tray 1 has a rectangular thin, plate-shaped configuration. A plurality of concave housing portions 2 on which are placed semiconductor devices, are formed in lengthwise and crosswise aligned rows in a surface of the IC tray 1.

Respective end tabs 3 are provided integrally with both end portions on the short sides of this IC tray 1 so as to bulge outwards from a tray body 1a.

As shown in FIG. 2, a cross section of the portion that bulges out from the tray body 1a of these end tabs 3 is configured as a U-shaped member, and a surface 32 thereof is flat. A side surface 32 that is suspended from the surface 31 is also flat. A square groove 34 that extends in the longitudinal direction of the end tab 3 is also formed in a rear surface 33 of the surface 32.

Dimensions of the end tabs 3 are determined by the Standards. The length is 92.1 mm, the width of the surface 31 is 5 mm, the width of the side surface 32 is 3.5 mm, the width of the rear surface 33 is 3.8 mm, the width of the square groove 34 is 1.3 mm, and the depth of the square groove 34 is 1.5 mm.

The end tabs 3 are used when an IC tray 1 is being transported. A transporting robot that transports the IC tray 1 inserts arms into an underside of the two end tabs 3 respectively, lifts up the IC tray 1, and then transports it.

Heat resistant properties that enable it to withstand a maximum temperature of 150° C. and antistatic properties based on a surface conductivity for surface electrical resistance values of 10⁵ to 10¹² Ω/sq. (based on ASTM D-257 (or JIS K 6911) the same applies below) are required in this IC tray 1. The IC tray 1 is formed by the injection molding of a heat resistant resin such as polyphenylene ether (PPE), polyphenylene sulfide (PPS), and polyether ether ketone (PEEK) that has been combined with a conductive filling material such as conductive carbon black, carbon fiber, and ceramic fiber.

Note that, both when semiconductor devices are housed or are not housed in the housing portions 2 a plurality of the IC trays 1 may be stacked on top of each other and used.

Moreover, as a measure for more effectively retaining the aforementioned antistatic properties that is not yet widely known, it has been suggested in the literature that a surface active agent be used as an antistatic agent as well in the synthetic resin in an actual manufactured IC tray. A variety of types of surface active agent can be used in this case including anion based agents, cation based agents, amphoteric agents, and nonionic agents, and the surface active agent can be appropriately selected in accordance with the type and nature of the matrix synthetic resin into which it is mixed.

Next, a marking clip of the present invention will be described.

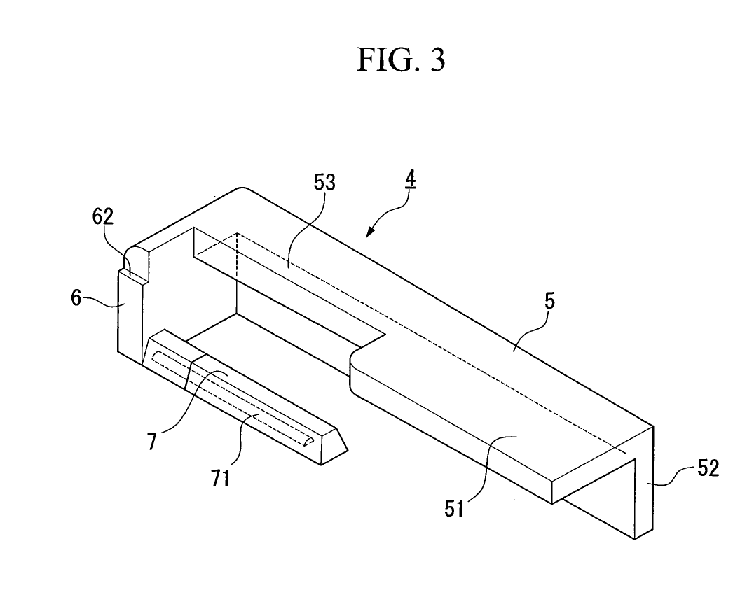

FIG. 3 shows an example of the marking clip of the present invention. The marking clip 4 of this example is integrally formed by a display piece 5, a connecting piece 6, and a press-insertion piece 7.

The display piece 5 is further formed by a top plate portion 51 and a side plate portion 52, and has a substantially L-shaped cross section. The top plate portion 51 has a narrow elongated plate shape, and a portion thereof that is on the connecting piece 6 side is cut out so as to form a narrow width portion 53. The side plate portion 52 has a narrow elongated plate shape that hangs down from one end surface of the long side portion of the top plate portion 51.

The dimensions of the display piece 5 are as follows. The length of the top plate portion 51 is 20 mm, the width of the base end portion of the top plate portion 51 is 2.9 mm, the width of the distal end portion of the top plate portion 52 is 5.0 mm, the thickness of the base end portion of the top plate portion 51 is 1.2 mm, the thickness of the distal end portion of the top plate portion 52 is 1.2 mm, the length of the side plate portion 52 is 20 mm, the width of the side plate portion 52 is 2.76 mm, the thickness of the base end portion of the side plate portion 52 is 1.2 mm, and the thickness of the distal end portion of the side plate portion 52 is 1.2 mm.

When the marking clip 4 is installed on the end tab 3 of the IC tray 1, the display piece 5 is disposed on the surface 31 side of the end tab 3. The display piece 5 that has been installed on the end tab 3 may have a slight distance from the surface 31 of the end tab 3 or may be in light contact with the surface 31 of the end tab 3.

Displays of colors, patterns, and characters or the like are made on the entire surface or on a portion of the surface of the top plate portion 51 and side plate portion 52 of the display piece 5. A variety of types of display may be used and, if color is used, then four or more colors are used. By employing diverse displays such as these, a large number of IC trays can be identified and classified.

The connecting piece 6 is provided integrally with the display piece 5 so as to hang down from one end portion (i.e., the aforementioned base end portion) in the longitudinal direction of the display piece 5. The connecting piece 6 has a square, plate-shaped planar configuration. The width of the connecting piece 6 is slightly larger than the width of the top plate portion 51 of the display piece 5, and a step portion 62 is formed at an intersecting portion of the connecting piece 6 and the top plate portion 51. The dimensions of the connecting piece 6 are height: 4.4 mm, width: 5.3 mm, and thickness: 1.2 mm.

The connecting piece 6 connects the display piece 5 with the press-insertion piece 7. When the marking clip 4 is installed on the end tab 3 of the IC tray 1 the connecting piece 6 is positioned so as to face an end surface in the longitudinal direction of the end tab 3.

If necessary, by providing a display such as colors, patterns, and characters or the like on the surface of the connecting piece 6 as well, the connecting piece 6 can be furnished with the same display function as that of the display piece 5.

The press-insertion piece 7 is a bar-shaped member that extends from a bottom end portion on an inner side surface of the connecting piece 6, which portion is also on the step portion 62 side, towards the display piece 5 side, and has a trapezoidal-shaped cross section. A distal end portion of the press-insertion piece 7 is also formed having a taper that is cut at an angle of approximately 75 degrees such that the press-insertion piece 7 can be easily inserted into the square groove 34. Furthermore, a concave portion 71 having a semicircular cross-sectional configuration is formed on a bottom surface of the press-insertion piece 7 extending in the longitudinal direction of the press-insertion piece 7 from the vicinity of a base end portion of the press-insertion piece 7 to the vicinity of a distal end portion thereof. By providing this concave portion 7, the press-insertion piece 7 can be easily elastically deformed in the width direction using a small amount of force.

When installing the marking clip 4 on the end tab 3, the press-insertion piece 7 is elastically deformed allowing it to be press-inserted into the square groove 34 of the rear surface 33 of the end tab 3. Both side portions of the press-insertion piece 7 are pressed against inner surfaces on both sides of the square groove 34 by their own elastic repulsion. Namely, the press-insertion piece 7 is in placed in pressure contact using elasticity. As a result, the marking clip 4 can be held in place on the end tab 3.

The dimensions of the press-insertion piece 7 are length: 10 mm, width of the top portion: 0.75 mm, width of the bottom portion: 1.4 mm, thickness: 1.0 mm, and radius of curvature of the concave portion 71: 0.2 mm.

Because the above described marking clip 4 is normally baked (i.e., undergoes heat treatment) together with the IC tray on which IC chips have been placed for 6 to 48 hours at a temperature of 125° C. to 150° C., it is important for the marking clip 4 that there is no heat deformation or breakage in this type of environment as well. Accordingly, it is important that the material used to form the marking clip 4 is provided with the same heat resistance as that of the resin material used to form the IC tray, and that this material is a synthetic resin material that has suitable elasticity. Polyester based thermoplastic elastomers and the like can be selected as this synthetic resin material.

While the material used to form the marking clip 4 of this embodiment is a polyester based thermoplastic resin, among such resins those having a good balance of a high modulus of elasticity and fibrousness are used. Specifically, “Hytrel” (trade name)—manufactured by Toray and Du Pont—a block copolymer of polybutylene terephthalate (PBT) and polyether) and “Primalloy” (trade name—manufactured by Mitsubishi Chemicals) and the like may be used.

A marking clip made from this “Hytrel” is resistant to deformation even in a thermal environment of 150° C., and additionally has excellent elastic contact with the end tabs of the IC tray. Furthermore, it maintains the same ability to be detached and reattached as in its initial state even after being baked ten times for 24 hours at 150° C.

In the same way as for the IC tray, antistatic properties based on a surface conductivity for surface electrical resistance values of 10⁵ to 10¹² Ω/sq. are required in this type of polyester based thermoplastic elastomer. The marking clip can be manufactured by using an injection molding process to mold a resin composition obtained by proportionally mixing and kneading together a conductive filling material such as carbon black, carbon fiber, and ceramic fiber, an antistatic agent made up of a variety of surface active agents, coloring agents and the like.

Note that, in addition to the above, as the conductive filling material it is also possible to employ Fullerene, carbon nanotubes, and metal fibers, for example, stainless steel fibers, aluminum powder, tin oxide powder, zinc oxide powder, and the like.

Although it also depends on the type of synthetic resin used, the object of the present invention can be achieved by compounding these conductive filling materials in a suitable proportion of 150 parts by weight or less to 100 parts by weight of synthetic resin. Too high a compound proportion of the conductive filling material is not preferable as this may cause a deterioration in the physical characteristics such as a reduction in the desirable elasticity in the synthetic resin, or may cause defects in the external appearance such as coloring defects. An excessively low proportion of 5 parts by weight or less does not allow the expected effects to be sufficiently demonstrated.

Moreover, in order for the aforementioned surface conductivity to be obtained, a number of types of surface active agent can be used as the antistatic agent irrespective of whether they are anion based agents, cation based agents, amphoteric agents, and nonionic agents, and the surface active agent can be appropriately selected in accordance with the type and nature of the matrix synthetic resin into which it is mixed.

For example, fluorine based surface active agents such as fluoroalkyl carbonate, perfluoroalkyl carbonate, perfluoroalkyl benzene sulfonate, perfluoroalkyl quaternary ammonium, and perfluoroalkyl polyoxyethylene ethanol, nonionic agents such as polyoxyethylene octylphenyl ether, polyoxyethylene alkyl ether, and polyoxyethylene sorbitan fatty acid esters, and amphoteric surface active agents such as N, N-dimethyl-N-alkylamino betaine acetate, and 2-alkyl-1-hydroxyethyl-1-carboxymethyl imidazolinium betaine can be favorably used. Naturally, combinations of a plurality of types of these surface active agents can be used, and it is also possible for these surface active agents to be used in combination with a conductive filling material. By selecting a variety of combinations, even greater effects can be expected.

Although it also depends on the type of synthetic resin used, the object of the present invention can be achieved by compounding these surface active agents in a suitable proportion of 10 parts by weight or less to 100 parts by weight of synthetic resin. Too high a compound proportion of the surface active agent is not preferable as this may cause a deterioration in the characteristics of the synthetic resin or may cause defects in the external surface properties and condition of the molded clip. An excessively low proportion of less than 0.01 parts by weight does not allow the desired objectives to be satisfactorily achieved.

The simplest and most easily performed method of forming a display on the surface of the display piece 5 is to use coloring that is obtained by adding color as is desired to the entire marking clip 4 using a coloring agent that is mixed in the resin material. In addition to this, methods may include the printing, stamping, transfer and the like of characters, symbols, patterns, barcodes, two-dimensional codes, and the like onto the display surface of the display pieces 5. As a colorant imparting color, an ordinary colorant containing an ordinary pigment may be used; however, a colorant containing a fluorescent dye, a fluorescent pigment, a luminous pigment, or the like is all the more effective in some cases.

Furthermore, fixing, removably attaching, or embedding a tiny radio IC tag (abbreviated below to “IC tag”) known as an RFID (radio frequency identification) tag in the display piece 5 or connecting piece 6 is also important as a method of forming a display in the present invention. This IC tag is identified by a reader (i.e., a recognition device) that is provided with a microcomputer and exchanges information with the IC tag by receiving and transmitting microwaves or the like. In the present invention, it is possible to classify the IC trays into a number of types and identify these by furnishing the marking clip 4 with a suitable one of the above described variety of display methods.

By preparing a large number and variety of marking clips 4 having different display contents (i.e., marked contents) in the display pieces 5 and then fitting these marking clips 4 in the end tabs 3 of the IC trays 1, the IC trays 1 can be classified into a number of types according to objectives, and then identified.

Moreover, because it is possible to include a larger quantity of information in an IC tag compared to a barcode, information on the baking conditions on each occasion in the baking history of the IC tray and on the number of bakings, or a history of such information about the clip itself may be input and stored. Consequently, an estimation of the state of deterioration obtained from the heat history of the trays and clips may be made, and control of the limits on repeated use of the trays and clips can be performed easily.

Note that because marking clips and IC trays are baked (i.e., undergo heat treatment) as is described above, the IC tags are also exposed to baking for 6 to 48 hours at 125° C. to 150° C. together with the marking clips and trays. Therefore, it is vital that the devices themselves as well as their memory information are not destroyed under such environmental conditions. Accordingly, as the IC tags used in the present invention, IC tags that are themselves provided with resistance to heat and are sold commercially as heat-resistant IC tags may be selected, or minute IC tags that are covered to a sufficient thickness using capsules made from a heat insulating material that allows radio waves to be transmitted through it such as a ceramic foam body, for example, foam bodies made of silicate sponge, silicone rubber, or fluorine rubber may be selected. Examples of such commercial products include the “V680 series” (trade name) manufactured by Omron Ltd. which has a heat resistance temperature of 200° C., and “μ-Chip” (trade name) manufactured by Hitachi Ltd. which is 0.4 mm square, has a thickness of 60 μm, and has a heat resistance temperature of 120° C. In the case of “μ-Chip”, by forming the heat resistant covering layer to a sufficient thickness, a performance of resisting heat to a temperature of 150° C. for 48 hours can be expected.

The marking clip 4 is installed on the end tab 3 of the IC tray 1 by pressing the press-insertion piece 7 into the square groove 34 in the end tab 3 from an end portion in the longitudinal direction of the end tab 3. The marking clip 4 is held in position in the end tab 3 by the elastic force of the press-insertion piece 7.

Moreover, the marking clip 4 can be detached by pulling the clip 4 from the end tab 3.

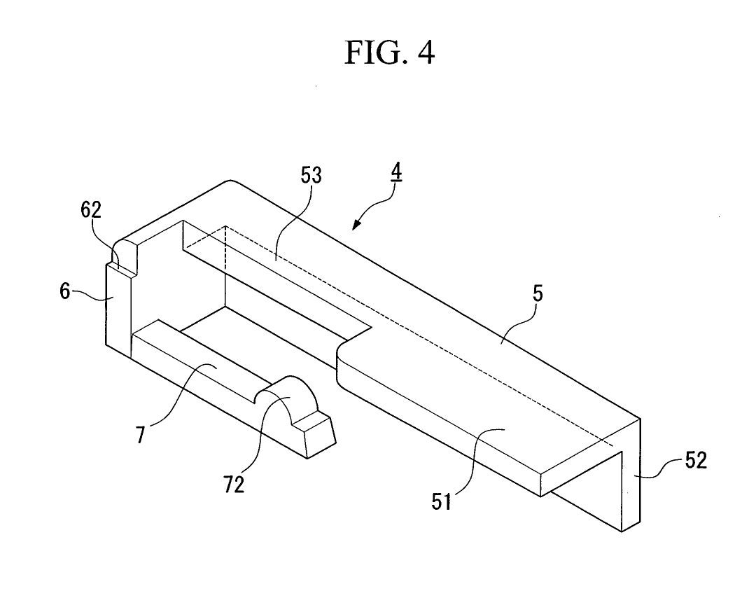

FIG. 4 shows another example of the marking clip of the present invention. Component elements thereof that are the same as those in FIG. 3 are given the same symbols and a description thereof is omitted.

The marking clip 4 of this example differs from that of the previous example in that the bottom surface of the press-insertion piece 7 is flat, and a convex portion 72 that has a semicircular cross-sectional configuration is formed in the vicinity of a distal end portion of the top surface thereof.

In the marking clip 4 of this example, when this marking clip 4 is installed in the end tab 3, the convex portion 72 of the press-insertion piece 7 is placed in contact elastically with a bottom surface of the square groove 34 of the end tab 3 so that the end tab 3 is elastically sandwiched between the press-insertion piece 7 and the display piece 5, and the marking clip 4 is held in position.

The composition of the material forming the marking clip 4 of this example and the method of molding it are the same as those in the example shown in FIG. 3.

Next, a comparison was made between the two clips that had both been molded using the above described material while having different press-insertion methods, namely, the clip shown in FIG. 3 and the clip shown in FIG. 4 as to whether or not it was possible to attach and detach both clips as well as how easy it was to attach and detach both clips in a variety of IC trays in common use. As a result, it became clear that the design shown in FIG. 4 was able to be used in a broader range of IC trays. It is thought that this was because, although the design dimensions of the end tab portion are regulated by a JEDEC Standard, there are differences in the detailed dimensions of the actual end tab portions of each IC tray.

TABLE 1

| IC Tray Type | FIG. 3 Clip | FIG. 4 Clip |
|---|---|---|
| LQFP20X20X1.4 | C | A |
| PBGA27X27 | A | A |
| LQFP14X14X1.4 | B | A |
| FBGA13X15 | A | A |
| TQFP7X7 | D | A |
| PBGA35X35 | B | A |
| LQFP28X28 | D | A |
| LQFP10X10X1.4 | A | A |
| SSOP 375milX48p | A | A |
| TQFP7X7 | A | A |
| 8VE02HA | A | A |

The above table shows the results of a comparison between the clip shown in FIG. 3 and the clip shown in FIG. 4 as to whether or not it was possible to attach and detach both clips as well as how easy it was to attach and detach both clips in a variety of thin IC trays based on JEDEC Standards. The symbols in the table represent the following evaluations—A: attachment and detachment can be smoothly achieved and the marking clip does not fall out, B: no particular problems as to use, however, force needed when attaching and detaching, C: installation possible, however, marking clip tends to fall out, and D: attachment and detachment not possible.

Although not particularly illustrated in the drawings, a further example of the marking clip of the present invention is one in which, without providing the convex portion 72 of the second embodiment, the entire press-insertion piece 7 is formed so as to slope upwards slightly approaching the distal end thereof. When the press-insertion piece 7 is press-inserted into the square groove 34 of the end tab 3, the entire top surface thereof is elastically in contact with the bottom surface of the square groove 34.

A structure that forces the press-insertion piece 7 of the marking clip of the present invention to be pressed elastically against the inner surface of the square groove 34 of the end tab 3 in this manner can be appropriately changed to match the dynamic characteristics of the synthetic resin that forms the raw material thereof.

A marked IC tray of the present invention shows that it is in a state in which the above described marking clip 4 has been installed in the end tab 3 thereof, and the IC tray 1 that is identified in this state is provided for use.

The IC tray identification method of the present invention is employed to install the above described marking clip 4 on the end tab 3 of the IC tray 1, and makes easy classification and identification of the IC tray 1 possible.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

### INDUSTRIAL APPLICABILITY

The present invention relates to a marking clip for an IC tray that is removably attached to an end tab of an IC tray, the IC tray being formed in a rectangular thin-plate shape with a plurality of concave housing portions on which are placed semiconductor devices being formed in lengthwise and crosswise aligned rows in a surface of the IC tray, and the end tab having an L-shaped cross section and being formed so as to protrude at both edges of short sides of the IC tray, wherein the marking clip for an IC tray is provided with: a display piece that is placed on a front surface side of the end tab; a press-insertion piece that is press-inserted into a groove on a rear surface side of the end tab; and a connecting piece that is placed on an end surface side of the end tab and connects the display piece to the press-insertion piece, and wherein a display for identifying an IC tray is shown on the display piece or on the connecting piece or a member for identifying an IC tray is attached to the display piece or the connecting piece. According to the marking clip for an IC tray of the present invention, it is possible to reliably identify what kind of condition or situation semiconductor devices that are contained on an IC tray that is equipped with this marking clip are in.

1. A marking clip for an IC tray that is removably attached to an end tab of an IC tray, the IC tray being formed in a rectangular thin-plate shape with a plurality of concave housing portions on which are placed semiconductor devices being formed in lengthwise and crosswise aligned rows in a surface of the IC tray, and the end tab having an L-shaped cross section and being formed so as to protrude at both edges of short sides of the IC tray, the marking clip comprising:
a display piece that is placed on a front surface side of the end tab;
a press-insertion piece that is press-inserted into a groove in a rear surface side of the end tab; and
a connecting piece for connecting the display piece to the press-insertion piece, the connecting piece being placed on an end surface side of the end tab,
wherein a display for identifying an IC tray is shown on the display piece or on the connecting piece or a member for identifying an IC tray is attached to the display piece or the connecting piece.

2. The marking clip for an IC tray according to claim 1, wherein the press-insertion piece is pressed against an inner surface of the groove in the rear surface side of the end tab by its own elastic force.

3. The marking clip for an IC tray according to claim 1, wherein a concave portion that enables the press-insertion piece to be elastically deformed easily is formed in the press-insertion piece such that the press-insertion piece is pressed against side surfaces of the groove by its own elastic force.

4. The marking clip for an IC tray according to claim 1, wherein a convex portion is formed near a distal end of a top surface of the press-insertion piece such that the press-insertion piece is pressed against bottom surface of the groove by its own elastic force.

5. The marking clip for an IC tray according to claim 1, wherein the display piece, the press-insertion piece, and the connecting piece are formed as a single body from synthetic resin.

6. The marking clip for an IC tray according to claim 5, wherein the synthetic resin is provided with conductivity or antistatic properties as a result of a conductive filler or surface active agent being mixed in the synthetic resin.

7. The marking clip for an IC tray according to claim 1, wherein the display used for identification is a color on the surface of the display piece.

8. The marking clip for an IC tray according to claim 1, wherein the member used for identification is an IC tag that is attached to or embedded in the display piece or the connecting piece.

9. A standardized IC tray that is formed in a rectangular thin-plate shape with a plurality of concave housing portions on which are placed semiconductor devices being formed in lengthwise and crosswise aligned rows in a surface of the IC tray, and an end tab having an L-shaped cross section being formed so as to protrude at both edges of short sides of the IC tray, wherein the marking clip for an IC tray according to claim 1 is fitted on the end tab.

10. A method of identifying an IC tray that is formed in a rectangular thin-plate shape with a plurality of concave housing portions on which are placed semiconductor devices being formed in lengthwise and crosswise aligned rows in a surface of the IC tray, and an end tab having an L-shaped cross section being formed so as to protrude at both edges of short sides of the IC tray, the method comprising:
fitting the marking clip for an IC tray according to claim 1 on the end tab, and
identifying the IC tray by the display for identifying an IC tray or by the member for identifying an IC tray.
